(19) United States
(12) Patent Application Publication
(10) Pub. No.: US 2002/0143759 A1
(43) Pub. Date: Oct. 3, 2002

(54) Computer searches with results prioritized using histories restricted by query context and user community

(76) Inventor: Allen Kai-Lang Yu, San Marino, CA (US)

Correspondence Address: HEWLETT-PACKARD COMPANY, Intellectual Property Administration, P.O. Box 272400, Fort Collins, CO, 80527-2400, US

(21) Appl. No.: 09/818,131

(22) Filed: Mar. 27, 2001

(51) Int. Cl. G06F 17/30

(52) U.S. Cl. 707/5; 707/10

(57) ABSTRACT

A search system prioritizes search-response items according to search-histories defined by two-dimensional search contexts: query context and user community. The query context is basically a query string derived from the user's search request. The community can be selected by the user or assigned by the search engine. A user can indicate interest in a search-response item by clicking on an excerpt for further exploration. The search engine associates each interest indication with the query context and the community. Thus, when an item has been returned in response to a search, a hit count for that item in the context of the present query and present community is available for prioritizing. The two dimensionally-restricted search history provides for better-targeted prioritization of search documents.

### BACKGROUND OF THE INVENTION

The present invention relates to computing and, more particularly, to computer-based searches. A major objective of the present invention is to provide for more effective prioritizing of search results.

Computers have made searching for computer-based documents and other items a routine task. For example, a user today routinely searches millions of documents stored on a network or on the Internet based on just a small set of keywords that the user enters. Often, the main problem is not finding items, but how to manage the abundance of items found in the search. In general, it is not useful to present a very large number of search response items in a substantively arbitrary order, e.g., alphabetical order.

Many search engines urge and instruct users to better frame their search requests to limit the number of irrelevant response items. However, such well-framed requests are not always feasible. Also, many users are discouraged by having to recast a search request; and they may not make the effort to develop more sophisticated search skills. Accordingly, it has fallen on the search engine to implement some filtering or prioritization strategy.

A search engine can prioritize based on item content: for example, items in which search terms appear the most times or most frequently can be ranked higher than other items. More sophisticated content-related prioritization can use probabilistic categorization techniques, such as Bayesian networks, to rank an item's priority based a relevance probability derived from the results of matching the document's word distribution to strategically selected word patterns. Typically, items assigned a high priority are presented to the user before (or higher on a list) of response items.

Alternatively or in addition, a search engine can exclude items that otherwise meet the search criteria based on user classification. For example, a search for “mouse” might exclude items relating to computer-input devices when a user is classified as “interested in pets”. The class can be user-selected (as a button on a search form) or assigned by the search engine-e.g., on the basis of a pre-existing user profile.

Meta-categorization—the association of additional information with documents to support a more refined and semantically based categorization scheme—can be used to further define relevancy with respect to user classification. For example, keywords, e.g., “pet community”, that appear to search engines but not in the body of the item itself can be added to a document's meta-description to indicate whether that document referring to a “mouse” might be interesting to the pet community, but not necessarily to the computer community. However, entering and updating meta-keywords for a large and rapidly changing set of search items can be very costly. If the search engine is to cater to diverse communities, the maintaining of such meta-categorization information is often not feasible.

Search engines can use search histories to aid in prioritization without requiring prior meta-categorization or classification of documents. In historical prioritizing, a search engine tracks the collective users' responses to search items. Indication of interest in specific search-response items can be defined, for example, as the act of a user clicking on a selected item for further inspection. If another user makes the same search, items indicated as interesting by previous users can be given higher priority. As more users make the same search, a statistical profile of items of interest can be accumulated and used for future prioritization.

The foregoing search approaches can be used individually or combined. For example, a search engine can limit the response items to those having matching meta-keywords and then prioritize based on the interest indications by prior users. However, even when used collectively, it can be difficult to achieve relevant prioritizations tailored to the specific interests of each user. What is needed is a search approach that can provide more personalized, relevant and useful prioritizations of search items.

SUMMARY OF THE INVENTION

The present invention provides a search engine that prioritizes items returned in response to a present search request by a present user according to an algorithm that assigns greater weight to interest indications by similar users making similar requests than to interest indications by users that are dissimilar or that have made dissimilar requests. In a simple realization, the user is assigned to a unique community and the search request is assigned to a unique query context. Only interest indications made by members of the same community in the same query context are considered in prioritizing search results. Alternatively, users or requests or both can be classified hierarchically, and interests weighted as a function of the specificity of the community and/or query contexts.

The method of the invention involves assigning the user to a community and the request to a query context, submitting a query associated with the query context and retrieving corresponding response items, prioritizing the response items based on a community and query context, and recording interest indications with respect to a community and query context for future prioritizations. The “search request” can be a natural language request made by a user, while the “query” is a formal search string (e.g., Boolean expression) submitted by the search engine to institute the search. Typically, many similar but distinct search requests can be assigned to a common query context; in this sense, the query defines a “context” for a search request.

Search histories are evaluated on a per-community basis. Interest indications can be tracked per community. Alternatively, interest indication can be tracked per user, and the community interest data can be derived from the user interest data either on demand or at regular intervals. Tracking interest by community enables anonymous search and makes sense when users frequently and freely change communities from search to search. Tracking interest by individual users, however, enables search engines to discover communities dynamically so that user classifications can be defined automatically.

Whether interest indications are tallied per community or per user, the invention also provides for “decaying” interest indications. Decaying permits newer interest indications to be weighted more heavily than older interest indications in prioritizing items. The decay can be implemented by associated a time with each hit or each hit count and using that time in determining a new hit count or a new hit-count weighting.

Prior art methods of prioritizing search results using search histories classify interest indications in one dimension, e.g. query context. The present invention considers a two-dimensional context—referred hereto as the search context, which is composed of the query context and the community context—in prioritizing search-response items. In other words, the present invention tracks histories for each combination of query context and community context. Both query context and community context are used to determine weightings for interest indications (or in the special case, to determine which interest indications are considered). This two-dimensional classification scheme substantially enhances the pertinence of the prioritization to the present user.

Relative to prior art methods in which search items are pre-determined or a priori classified, the present invention provides a mechanism for communities of end users to collectively and dynamically evaluate and define the relevance of search items for their own use. The evaluation is automatic, not requiring pre classification by those responsible for the search engine or the items being searched. Besides offering a more flexible mechanism for defining relevancy, the proposed methods also offers a more responsive mechanism to meet today's rapidly changing search conditions. These and other features and advantages of the invention are apparent from the description below with reference to the following drawings.

### BRIEF DESCRIPTION OF THE DRAWINGS

FIG. 1 is a schematic illustration of a search system in accordance with the present invention.

FIG. 2 is a diagram of a relational database of the present invention incorporated in the search system of FIG. 1.

FIG. 3 is a method of the invention practiced in the context of the search system of FIG. 1.

### DETAILED DESCRIPTION OF THE PREFERRED EMBODIMENTS

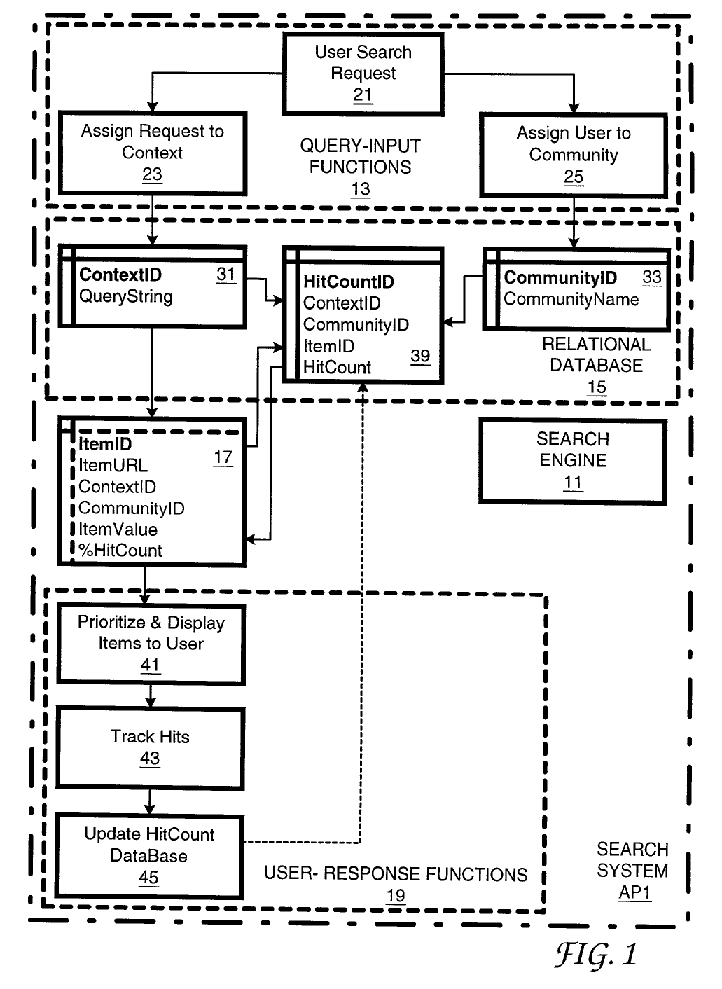

In accordance with the present invention, a search system AP1 comprises a search engine 11, search input functions 13, a relational database 15, a temporary response-item list 17, and user-response functions 19, as shown in FIG. 1. Search engine 11 interacts with all elements of search system AP1. Search input functions 13 include a search-request input function 21, a request-to-query assignment function 23, and a user-to-community assignment function 25. User-response functions 17 include a prioritize-and-display function 41, a hit-tracking function 43, and a hit-count-update function 45.

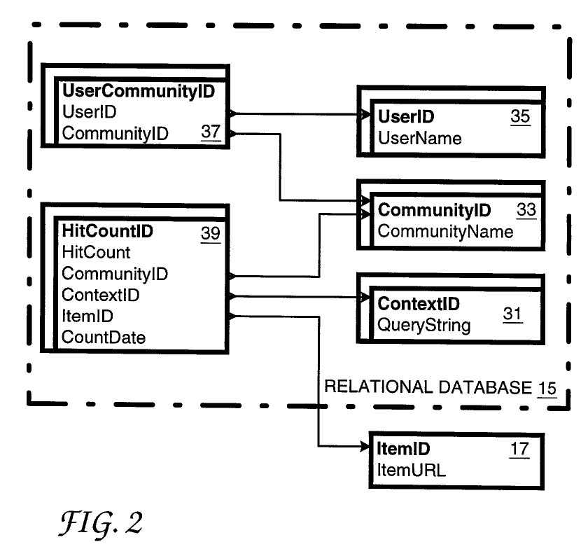

Relational database 15 is shown in greater detail in FIG. 2 comprising a query table 31, a community table 33, a user table 35, a user-community table 37, and a hit-count table 39. Query table 31 has a query serial number (QueryID) as a key field and query string field (QueryString) and a parent-query field (ParentQueryID). The query serial number for a search request is determined by request-query-assignment function 23. The query string field indicates the actual query string to be submitted by search engine 11 in executing the search. The parent-query field allows query table 31 to refer to itself recursively to allow for the definition of hierarchical query contexts.

Community table 33 uses a community serial number (CommunityID) as a key and and includes a community-name field (CommunityName), a parent-community field (ParentCommunityID), and a decay-factor field (HalfLifeDecayFactor). The community name is used in the user interface. For example, the community name may be the name presented to allow a user to select a community. User table 35 has a user serial number key field (UserID) and user names are given in a UserName dependent field. The user fields are analogous to the counterpart community fields in community table 33. The parent-community field allows the community table to refer to itself recursively to allow hierarchical community contexts to be defined. The decay-factor field specifies the way in which interest indications are aged so that newer indications are weighted more than older indications.

User-community table 37 has a UserCommunityID key field, and has UserID and CommunityID as dependent fields. These dependent fields are related to key fields, respectively, for user table 35 and community table 33. Each record in user-community table 37 associates a user with a community. However, a user can be associated with different communities in different records; of course, a community can be associated with different users in different records. User-community table 37 thus allows users to belong to more than one community for a search. Embodiments permitting only one community per user can dispense with a user-community table and just include a community dependent field in the user table.

Hit-count table 39 provides the actual history data for prioritizing response items. The key field is a hit-count serial number (HitCountID); a hit count (HitCount) is determined for each hit-count serial number. Obviously, each hit count is associated with a specific response item (ItemID). Also, each hit count is associated with a specific query context (QueryID) so there are different counts for an item retrieved in response to distinct queries. The present invention further provides that each hit count is associated with a specific community, so there are different hit counts for different communities for the same items md query contexts.

Hit-count table 39 also associates a count date (CountDate) with each hit count. The date is the date of the most recent previous hit. The count date is used to apply an exponential decay factor when calculating a hit count. In an alternative embodiment, the hit count is merely a tally of hits. The illustrated embodiment employs the decay factor to give higher ranking to more recent hits, and increasing lesser weighting to “stale” hits.

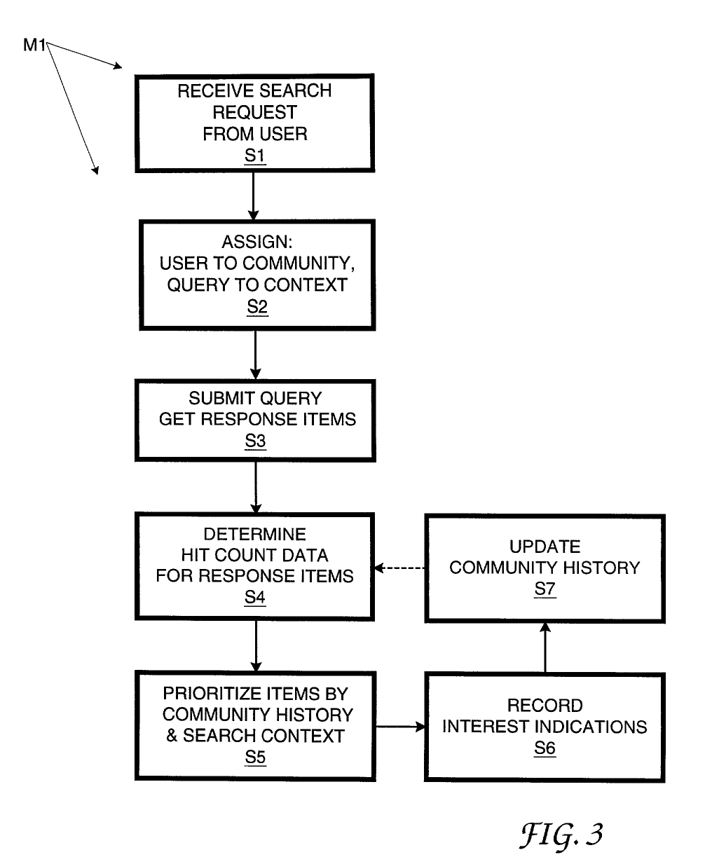

Search engine AP1 implements a method M1 flow charted in FIG. 3. At step S1, a search request is received by search request function 21. This can involve presenting a user a search form that the user can fill out. The user can use the form to submit a search request. For example, a user can submit a search request by typing in search terms such as “networking printers”. Optionally, the search form can present the user with a list of communities, e.g., “system administrators”, “computer vendors”, “end users” to join to help focus the search.

At step S2, the search request is assigned to a query context by request-query assignment function 23 and the user is assigned to a community by user-community assignment function 25. Request-query assignment function serves to parse the human input string (the search string) into a more mathematical, machine-readable format (the query string). For example, the search string “networking printers” can be parsed and translated to the query string “network & printer” by a Boolean parser. Other search strings, such as “network printers”, “printers on a network”, etc., can map to the same query string. The query string defines a query context, which can be hierarchical; hence a “network & printer” query might be assigned as a sub query context of the “printer” query. The categorization of search requests into contexts allows for more effective recording and retrieval of relevant hit counts for prioritization in future searches.

Also at step S2, the user is assigned to a community. The assignment can be based on the community selected at request time—i.e. the community specified on the search form (optionally) at step S1. For example, a user might be a member of a user community as opposed to a marketing community and would explicitly make the appropriate selections on the search form before performing a search. This selection of community will affect the ordering of items returned in the search.

Alternatively, the assignment of community can be determined by a profile, accessible to the search engine, associated with the user. The profile may be one directly submitted by the user, or indirectly submitted by an organization of which the user is a member.

Furthermore, the communities can be predefined as above or generated adaptively. For example, a search system can look for patterns in users' collective search history to discover new communities with similar search patterns. In the illustrated embodiment, both the communities and the query contexts are hierarchical. This allows for a well-rounded prioritization of search results even when a given community or query context contains a relatively sparse history.

In the illustrated embodiment, a user is allowed to join any number of communities and a community can consist of an arbitrary number of members. The ability to join multiple communities allows users to search under multiple contexts. This can be useful as in the case when a road bicyclist is searching for a racing event by searching under the contexts of both “road bicyclists” and “bicyclist racing.” Alternatively, this approach allows for users that change communities. For example, a user may elect a “pet” community when exploring mice as pets and a “computer” community when the user is interested in cursor control devices.

At step S3, the search is initiated by submitting the query string and search-response items are collected. The search items meeting the search criterion are gathered in temporary response-item table 17. The search items can belong to a formal database such as a corporate knowledge database or can be documents residing on the Internet, which are not arranged in a formal, centralized database.

The collected items stored in response-item table 17 are assigned record numbers, in this case an ItemID. In addition, the Universal Resource Locator (URL) for the document is stored. In addition, an item-content value can be stored as a prioritization factor. This can be the same value used in the prior art used for prioritization. For example, the number of occurrence of each search term can be considered, along with Bayesian considerations of the proximity with which search words appear within an item.

Response-item table 17 also includes a hit count field, but this is not determined from the document itself, but by accessing a hit-count table 39 in step S4. Hit-Count table 39 presents hit counts as a function of search item, query, and community. For each item in response-item table 17, table 39 is searched to see if there is a hit count for the presently assigned community and context. If there is, that hit count is entered into the % HitCount field of response-item table 17. In hit-count table 39, the queries are identified by the record number used in table 31, and communities are identified by the record number used in table 33. If no matching item is found in hit-count table 39, the hit count is zero. Of course, where hierarchical contexts (either query or community), the hit count is only zero if there is no matching item for the current context and all associated contexts.

The items are then prioritized and displayed at step S5. In the illustrated embodiment, the items can be sorted simply by hit counts. Alternatively, the content values for the items can be factored in. Thus, for two items with the same hit count, the one with the greater content value is given priority.

Once presented with the prioritized list of response items, the user may select some of them for further investigation. For example, each item may be presented with a page title and an excerpt from the page including one or more of the search terms. A user can review these “extracts”, and click on promising items to go to the associated URL. Each such pursuit is tracked as a hit at step S6.

At step S7, hit counts are updated in response to interest indications applied to the present response items. In the present case, the hit count for an item is updated in response to a hit of that item by adding 1 to a time-adjusted version of the old count. Of course, the count date is then updated to the present as well. If an item that is not represented in hit-count table 39 receives a hit, that item is then added to hit-count table with a hit count of 1; the present date is set as the count date. In alternative embodiments, decay is ignored and a hit count tally can simply be incremented. Either way, the interest indications shown in the present search are available for prioritizing search items in future (indicated by dashed arrow) searches involving the same community and query context.

If query contexts are hierarchical, the returned results can be ordered in a more well-rounded manner. Interest indications associated with ancestor query contexts can be factored into a hit count in addition to the interest indications associated with the present query context. Preferably, the interest indications are weighted less the more generations away the associated ancestor context is to the present query context. For performance, some arbitrary cutoff can be used to limit the number of generations considered in the count. For example, suppose that the history for the query context “network printers” has not been established for a given community. Instead of returning a count of 0, the system might query the parent context of “network printers”, e.g., “printers”, which might have a more established history to derive a related count.

In a manner analogous to that described above for query contexts, communities can be hierarchical so that parent community contexts can be used to return a more well-rounded search result as well. Consider the case where a new community called “water painters” is created under a parent community called “visual artists.” Initially, when little history is established for the “water painters” community, the history of the parent community “visual artists” can be used to aid in prioritizing a search result for the “water painter” community. A weighting system similar to that used in nested query contexts, where weights are based on distance from the current context, can be used here as well For both community contexts and query contexts, it can be advantageous to include child contexts of the present context (and even of ancestor contexts) as well as ancestor contexts for the calculation of the count.

A common problem, regardless of whether hierarchical contexts are used, relates to the general mechanism of recording hit counts in search histories. If hit counts are not properly retired, outdated, formerly popular items are continually prioritized over more relevant and current items; this occurs because it takes time to register enough counts for the currently popular items to overtake counts of the old item. The invention provides for a mechanism of aging hit counts systematically and automatically by recording the date the count was last updated and systematically updating the count each time the count is to be incremented by the formula:

count=1+old_{—}HitCount*(e**−0.69*t/HalfLifeDecayFactor)).

More generally, the decay factor can be any function of time that varies from 1 to 0 as time varies from 0 to infinity. This scheme effectively allows recent hits to be given more weight, as would be appropriate, for example, when a new product appears on the scene, and allows “stale” hits to be retired from consideration in the prioritizing of search results.

There are two main methods by which one can record a search history that can be retrieved for future prioritization. As mentioned above, a search history can be established on either a per-user or a per-community basis. Where history is kept on a per-user basis, the community history can be calculated by aggregating the histories of its member users.

One advantage of per-user history approach is that, as users join and leave communities, the community history dynamically reflects the collective histories of its current users, including the effects caused by users joining and leaving the community. If a user with an established search history joins a new community, that community benefits from his entire history. Another advantage of keeping history on a per-user basis is that it allows the possibility to have a system discover new communities of users. In per-user tracking, the community history can be derived—either dynamically with each search request or periodically at fixed predetermined intervals—from the aggregate user histories. The exact mechanism of how a community history is derived from its user histories is a performance based implementation detail not central to the current invention.

A problem with per-user based history is that a user may have multiple interests, and his/her search history would reflect an amalgamation of those interests. As a result, the history of each of the communities to which he belongs will similarly reflect the amalgamation of his disparate interests. For example, if a user, who is both a linux user and a cat lover, joins the linux and cat communities, the linux community will register the user's cat related search history (and vice versa) as well! One viable solution is to more finely track a user's history based on the category of communities also. Another is to record history on a per-community basis.

The primary advantage of keeping a community-based history is the “non-sticky” way in which counts are recorded. Counts are recorded only to the current communities associated with the current search. This way, users are free to change interests many times and often simply by changing in and out of communities while the focus of communities stay relatively focused and steady. On the other hand, recording in a sticky-way allows a user to carry the user's past histories along to the new communities as the user joins and leaves communities. In such cases, the communities benefits (gains new history) as the user moves in and out of communities.

To get the best of both sticky and non-sticky ways of recording hits one can record on a per-user and per-community basis. This allows user history to be portable as the user joins and leaves communities while solving the amalgamations of interest problem identified earlier with respect to per-user tracking. In most applications though, it is believed community history tracking gives the best performance/feature combination. Hence, in the illustrated embodiment, history is recorded on a per-community basis.

In the illustrated embodiment, the search is conducted over the Internet, and items do not belong to a common formal database and are best considered as external to search system AP1. However, the invention is also applicable to searches of data in formal, centralized databases such as a corporate knowledge system. In that case, the item database can more fairly be considered part of the search system.

The present invention has industrial applicability to searches of documents and other items over the Internet or arranged in formal databases. The foregoing and other variations upon and modifications to the illustrated embodiment are provided for by the present invention, the scope of which is defined in the following claims.

What is claimed is:

1. A method in which search items returned in response to a present user's present search request are prioritized according to an algorithm which assigns greater weight to interest indications by relatively similar users making relatively similar search requests than to interest indications by relatively dissimilar users and than to interest indications making relatively dissimilar search requests.

2. A method as recited in claim 1 comprising the steps of:
receiving a search request from a user;
assigning said user to a community;
assigning said search request to a search query;
submitting said query so as to yield a set of response items; and
prioritizing said response items as a function of prior search requests by said community.

3. A method as recited in claim 2 further comprising tracking indications of interest by said user in individual ones of said response items and storing the results of said tracking on a per user and/or per-community basis.

4. A method as recited in claim 3 further comprising a step of using said results in prioritizing items collected in response to subsequent search requests by other users assigned to said community.

5. A method as recited in claim 3 wherein, all else being equal, interest indications associated with a community are given greater weight than other interest indications by the parent of said community.

6. A method as recited in claim 3 wherein said user is assigned to a community in part as a function of said indications of interest.

7. A method as recited in claim 2 wherein said user is assigned to a community as a function of a selection of said community by said user.

8. A method as recited in claim 2 wherein said user is assigned to a community as a function of a profile of said user existing before said search request is made.

9. A system comprising:
a search-request receiver for receiving a search request from a user;
a community assigner for assigning said user to a community;
a search-request parser for assigning said search request to a query;
a search engine for collecting search items in response to said query; and
a prioritizer for prioritizing said search items as a function of previous searches by said community.

10. A system as recited in claim 9 further comprising a tracker for tracking indications of interest by a user in search items collected in response to said search request from said user, said prioritizer using said indications of interest to determine said function for future queries.

11. A system as recited in claim 10 wherein said community assigner assigns said user to a community for said future search requests at least in part as a function of said indications of interest.

12. A database comprising:
a key field identifying hit counts;
a second field indicating a values for respective hit counts;
a query context field indicating query contexts for respective hit counts; and
a user and/or a community field indicating respective users and/or communities associated with said hit counts.

13. A database as recited in claim 12 further comprising a decay field for indicating times associated with said hit counts.

14. A database as recited in claim 12 further comprising of a period update system to update the community record counts from the user record counts.
